(19) United States
(12) Patent Application Publication
(10) Pub. No.: US 2024/0152939 A1
(43) Pub. Date: May 9, 2024

(54) SYSTEM AND METHOD OF CONTEXTUAL RECORD REPORTING

(71) Applicant: Crossbeam, Inc., Philadelphia, PA (US)

(72) Inventors: Robert J. Moore, Haddonfield, NJ (US); Lindsey DeFalco, Landenberg, PA (US); Francis Ryan, Media, PA (US)

(21) Appl. No.: 18/378,065

(22) Filed: Oct. 9, 2023

Related U.S. Application Data
(60) Provisional application No. 63/422,878, filed on Nov. 4, 2022.

(51) Int. Cl. G06Q 30/0201

(52) U.S. Cl. CPC G06Q 30/0201

(57) ABSTRACT

A system and method of reporting a contextual record, are described. Population data representing respective population segments of a first partner and a second partner is received. The respective population segments include a record overlapping between the first partner and the second partner. A first match time at which the record has a first record status for one of the partners is determined. In response to a change in the first record status to a second record status for one of the partners, a second match time of the record is determined. Report data, including the first match time and the second match time, is generated for display to represent a history of the record statuses.

This application claims the benefit of priority of U.S. Provisional Patent Application No. 63/422,878, filed on Nov. 4, 2022, titled “System and Method of Contextual Record Overlap Reporting,” which is incorporated herein by reference in its entirety.

### FIELD

This application relates to system and methods for mapping data in a partner ecosystem, and more particularly, for reporting contextual record movement or overlaps in populations of partners within the partner ecosystem.

### BACKGROUND

Organizations collaborate with other organizations. Organizations collaborate with partner organizations. For example, Company A and Company B may have overlap between customer pipelines (like shared prospective customers), or may collaborate to develop such overlaps. An overlap can be a good indicator that the companies have a potential partnership, or that the companies are already partners and have an opportunity to gain value from the partnership, e.g., by co-selling, co-marketing, etc. That is, Company A and Company B may be partners having an overlap of Company C that they both have some relation to. Company A and Company B can assist each other to further relationships, e.g., sales relationships, to Company C. For example, if Company C is a customer of Company A, a representative of Company A can: introduce Company B to Company C, give strategic advice to help Company B sell to Company C, or cross sell to Company C in collaboration with Company B by encouraging the purchase of complementary offerings. Another, non-sales, example is a co-marketing effort in which joint marketing efforts of Company A and Company B increase awareness and drives more pipeline to Company A or Company B.

### BRIEF DESCRIPTION OF THE DRAWINGS

The novel features of the invention are set forth with particularity in the claims that follow. A better understanding of the features and advantages of the present invention will be obtained by reference to the following detailed description that sets forth illustrative embodiments, in which the principles of the invention are utilized, and the accompanying drawings.

FIG. 1 is a block diagram of an example environment for reporting a contextual record overlap, in accordance with an embodiment.

FIG. 2 is a flowchart of a method of reporting a contextual record overlap, in accordance with an embodiment.

FIG. 3 is a pictorial view of an activity timeline indicating a contextual record overlap, in accordance with an embodiment.

FIG. 4 is a pictorial view of an activity timeline indicating a contextual record movement, in accordance with an embodiment.

FIG. 5 is a pictorial view of a report indicating a contextual record overlap, in accordance with an embodiment.

FIG. 6 is a pictorial view of a feed indicating a contextual record overlap, in accordance with an embodiment.

FIG. 7 is a pictorial view of an activity mapping matrix indicating contextual record overlaps between partners, in accordance with an embodiment.

FIG. 8 is a pictorial view of an activity mapping matrix indicating revenue totals of contextual record overlaps between partners, in accordance with an embodiment.

FIG. 9 is a pictorial view of an activity timeline indicating an attribution event, in accordance with an embodiment.

FIG. 10 is a pictorial view of a report indicating contextual record overlaps of several partners, in accordance with an embodiment.

FIG. 11 is a pictorial view of actionable contextual record overlaps, in accordance with an embodiment.

FIG. 12 is a block diagram of an example computing system that may perform one or more of the operations described herein, in accordance with some embodiments.

### DETAILED DESCRIPTION

Embodiments describe a system and method of determining, reporting, displaying, and/or otherwise using contextual record overlaps between partner populations. The system and method can be used in creating and surfacing actionable opportunities, e.g., sales opportunities, for collaboration between partners. However, the system and method may also be used to determine contextual record overlaps between other, non-sales data populations of various entities. Thus, reference to the system as being used for reporting contextual sales account overlaps is not limiting.

In various embodiments, description is made with reference to the figures. However, certain embodiments may be practiced without one or more of these specific details, or in combination with other known methods and configurations. In the following description, numerous specific details are set forth, such as specific configurations, dimensions, and processes, in order to provide a thorough understanding of the embodiments. In other instances, well-known processes and manufacturing techniques have not been described in particular detail in order to not unnecessarily obscure the description. Reference throughout this specification to “one embodiment,” “an embodiment,” or the like, means that a particular feature, structure, configuration, or characteristic described is included in at least one embodiment. Thus, the appearance of the phrase “one embodiment,” “an embodiment,” or the like, in various places throughout this specification are not necessarily referring to the same embodiment. Furthermore, the particular features, structures, configurations, or characteristics may be combined in any suitable manner in one or more embodiments.

In an aspect, a system and method to report contextual record overlaps is provided. A record overlap, also referred to as a record match, occurs when a record (e.g., company, person, account, lead, prospect, etc.) exists in a data set of a first partner and a data set of a second partner. The overlap can be calculated or determined to have a match time. The match time(s) of the overlap can correspond to a status of the account, or a change thereof. For example, a new match time can be generated for the overlap when an account is shared with a partner, an account moves from one population to another, or a definition of such population changes. The match time(s), which is/are based on the change(s), can be used to provide visibility to actionable opportunities that arise between the partners.

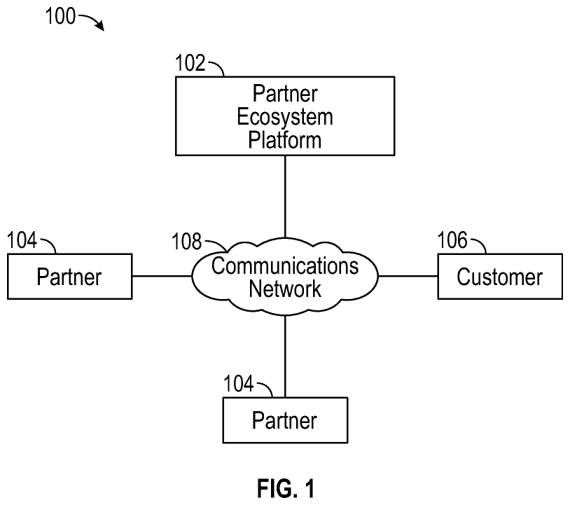

Referring to FIG. 1, a block diagram of an example environment for determining a contextual record overlap is shown in accordance with an embodiment. As shown, the environment 100 includes a partner ecosystem platform 102, which can be a computing system that is interconnected with one or more partner devices 104 and/or one or more customer device 106 via a communications network 108. The communications network 108 may be the internet, a wide area network (WAN), intranet, or other suitable network. The partner ecosystem platform 102 may be hosted on one or more local servers, may be a cloud based system, or may be a hybrid system with local servers and in the cloud. The partner ecosystem platform 102 is maintained by engineers which develop features and tools, such as an account mapping interface for partners of the partner ecosystem to interface with the partner ecosystem platform 102.

Although FIG. 1 shows only a select number of computing devices and/or systems (e.g., partner ecosystem platform 102, two partner devices 104, and one customer device 106), the environment 100 may include any number of computing devices and/or systems that are interconnected in any arrangement to facilitate the exchange of data between the computing devices and/or systems.

The systems and method described herein can create and surface actionable opportunities for collaboration between partners as deals move into, through, and out of a sales funnel. More recent opportunities for action may be inherently more desirable and likely to yield success, as compared to less recent opportunities. Identifying more recent opportunities may require visibility to historical movement and overlaps of records in populations of partners. Currently, however, such movements are not easily tracked. For example, identifying such movement may require performing a pipeline update with a team to manually validate whether an opportunity has moved. By contrast, the system and method described below provides visibility, automatically, to whether (and in what context) an open opportunity has moved into a partner's population or vice versa. Such visibility to movement and overlaps of records may be, for example, through an activity timeline, an account mapping matrix, an account map, or other display modes, as described below.

A population as used herein can be a segment of records of a partner, typically including companies or people that the partner has, or wants to have, some relationship to. For example, the population can have a particular status, such as being at a particular stage in the sales cycle. Account status or stages may include, for example, whether the population includes prospects, open opportunities, and/or customers. For example, the prospects population can include companies or people that the partner has no contact with but wants to turn into opportunities and then customers.

Populations can be standard or custom population segments. Standard population segments can be so named because they align most closely with the common sales cycle stages, e.g., stages in a sales funnel model, which are used by revenue teams to track account progress. For example, the standard populations can include prospects, open opportunities, and/or customers population segments. Prospects can include accounts that have no current partner relationship. Prospect accounts can be at the top of a sales funnel model. Open opportunities can include accounts that are beginning to be worked by representatives of the partner, e.g., to make the accounts customers or expand, e.g., renew, an existing customer relationship, and which have moved down the sales funnel model. Open opportunity accounts are actively owned by a representative, e.g., a sales representative, of the partner. Customers can include accounts that have a closed/won opportunity status and are considered customers of a partner. Customers can be paying customers or non-paying customers, depending on how the partner defines the customer.

Custom population segments can be defined by a set of filters on a partner's Customer Relationship Management (CRM) data. Custom populations may also be defined by a set of filters on a flat file that is uploaded via a comma-separated value file, or in a spreadsheet application, or other data sources. Custom populations can be named whatever the partner would like. A note can be included on the custom population as well for more context. These custom populations can provide further context for record overlaps in addition to the standard populations. Examples of both standard and custom populations being used to determine contextual record overlaps are described below.

An overlap may be defined as a record that exists in a population of a first partner and exists in a population of a second partner. For example, the first partner (e.g., Company A) can have a record (e.g., Account X) as a particular status (e.g., as a prospect), and the second partner (e.g., Company B) can have a record (e.g., Account X) as a particular status (e.g., as a customer). The record may therefore be an overlap because the record exists in populations of several partners.

The systems and methods described below provide for a data store that represents a view of a timeseries of changes and events that define influence and assist in taking action, as opposed to a stateful data store that merely represents an instantaneous, e.g., current, state. A key component of this timeseries paradigm is the tracking of “match time” as data changes inside partners' accounts. Match time can be a time at which an account in a specific population of a first partner matches with an account within a specific population of a second partner. Match time can also be a time when an account moves from a first population of a first partner to a second population of the first partner. More particularly, match time is a time, e.g., a date, of an overlap or a movement for a record. In the above example, Record X can change from being a prospect to being a customer for Company A, and may remain a customer for Company B. The record may therefore be associated with at least two match times. More particularly, Record X can have a first match time at which it became a prospect for Company A. The first match time can be associated with the first occurrence of the record in an event timeline within the system. A second match time can be a time at which Record X became a customer for Company A. A third match time can be when it became a customer for Company B. The contextual record overlap can therefore include several match times.

The system and methods described below can calculate match time to generate match data. Match time can include unique entries for match time across populations. More particularly, match time can include unique entries for every population of a first partner and a second partner. For example, the match times can include the most recent match time across populations of the partners. Alternatively or additionally, the match time can be determined based on the populations involved in a specific report. For example, groups of accounts shared between the partners can be selected, and corresponding match times for the groups can be determined or displayed. Rather than having a single match time for an account matching with a partner, multiple match times per account can be determined based on the account's movement through populations of partners, e.g., a first partner and a second partner. The matching of records is described in more detail below.

The system may show population movement. Population movement can be when specific records match in different populations of a same partner or different partners. This historical capture of match times can provide a time series of match times, in contrast to naïve overlap identification that merely determines whether an overlap exists without regard for context, e.g., timing, of the match. Population movement is described in more detail below.

Data may be imported by the partner ecosystem platform 102 from one or more data sources. The data may be imported once, or synchronized on an ongoing basis. The partner ecosystem platform 102 can import data by integrating with Customer Relationship Management (CRM) systems via their application programming interfaces (APIs). The partner ecosystem platform 102 can also import ad-hoc structured data via integrations with data warehouse databases. Customers can also upload comma separated value (CSV) formatted files or spreadsheet documents to the partner ecosystem platform 102. Such examples are provided by way of illustration and not limitation, and other data sources may be used.

Data imported by the partner ecosystem platform 102 can include data objects that represent accounts, leads, contacts, opportunities, or account executives. Such data objects are provided by way of illustration and not limitation. Data objects representing other groups, or representing the same group but named differently, may be used. For example, the imported data objects can include a customer accounts data object, which may be referred to as accounts (or companies) data, and can represent a currently active sales account. The imported data objects can include a sales lead data object, which may be referred to as leads data, and can represent unqualified leads, e.g., potential customers that are not yet in the sales pipeline. The imported data objects can include a contacts data object, which may be referred to as contacts data, and can represent known individuals employed by accounts or leads companies. Furthermore, leads often turn into contacts on accounts, and a lead could be a company or a person at a company. The imported data objects can include a sales opportunities data object, which may be referred to as opportunities (or deals) data, and can represent qualified leads, e.g., potential customers in the sales pipeline. The imported data objects can include an account owner data object, which may be referred to as users (or owner) data, and can represent an individual responsible for managing a customer account. Without any treatment or processing, the imported records are considered raw data. Field names within raw data records may vary depending upon the data source from which they originated.

Raw data can be processed by the partner ecosystem platform 102 to generate master records data. Master records data can include normalized field names and data. More particularly, master records data can include consistent representations of the imported data. The master records data may, for example, normalize customer accounts data objects from different CRM integrations to have the same data field names.

Raw records for account, lead, and contact records may also be normalized into a second standard format for use in the matching process described below. For example, accounts data may be stored with a normalized name that includes a corresponding canonical name of a corresponding account business, e.g., “Google,” and a domain name of the account business, e.g., “google.com.” Records without domains can go through a preprocessing step to predict and complete the record. For example, historical data may be used to determine a domain name of account data that does not include the domain name in the data object.

Population data can be segmented. More particularly, the partner ecosystem platform 102 can allow users to define rules for segmenting their imported data into populations using boolean logic. For example, a partner can define a population “Foo” as containing all accounts owned by a particular sales representative, e.g., John Smith, and created during a time range, e.g., on or after Jan. 1, 2023. The boolean logic that defines the population can be applied to the master record data described above, resulting in a filtered list of records that match the defined criteria. Populations may only include data of a single type from a single account, lead, or opportunity CRM source.

Population data can be shared. After segmenting population data, partners can share the records within a population with other partners on the partner ecosystem platform 102. Sharing may be configured by generating or configuring sharing rules for that population. Such rules can be modified at a partner level, per population, and per partner population. Accordingly, there may be specific sharing rules for sharing data when an overlap exists in a first population of a first partner and a second population of a second partner. Sharing may therefore be customizable.

In an embodiment, two partners mutually opt into a partner relationship. The partner relationship is established in the partner ecosystem platform 102 to link the partners. If there are default sharing rules or sharing rules configured for the partner relationship, such sharing rules are applied and the records for those populations are shared.

As described below, population data can include match data, or overlap data, that can be determined through a matching process. If a partner chooses to share overlap data, then the partner ecosystem platform 102 displays shared data only for records that are determined to be a matched record between respective records in the population data of a first partner and the population data of a second partner in the partner relationship.

Population data may also include non-overlap data. Such data corresponds to records that are not in the population data of both partners to the partner relationship. Non-overlap data may be referred to as greenfield data or whitespace data. When a partner chooses to share non-overlaps, once a population is shared, all records in the population data of the partner that do not match records in the population data of the second partner are made visible to the second partner. Notably, non-overlapping records may also be shared outside of population sharing. For example, accounts may be selected to create a shared list that makes the accounts visible, in a user interface, to a partner in the shared list.

In both cases described above—sharing of overlap data or non-overlap data—the sharing partner can define data segments that are used to limit the set of records that may be shared as overlaps or non-overlaps. When a first partner selects a population and shares that data with a second partner, a job is triggered that captures the date and time when that record becomes visible to the second partner in the context of the population from which that data was shared. The second partner may see multiple match times for the same record, because it can match with different partner populations over time. The new match time is specific to the overlap. It will be appreciated that partners may share overlap data and non-overlap data together. In that case, all records within the population data of the partners are shared, regardless of whether or not any records match with records of the other partner.

Population data can be matched. Matches are determined by comparing normalized record data of imported records. When the compared data meets certain criteria, the records can be determined to be matching, and match data representing the matching records can be stored.

There are several different ways that records can be determined to match. The partner ecosystem platform 102 can determine that a match exists when an account record of a first partner has a same domain name as an account record of a second partner. The partner ecosystem platform 102 can determine that a match exists when an account record of a first partner has an associated contact with a same email address as an associated contact of an account record of a second partner. The partner ecosystem platform 102 can determine that a match exists when two lead records have the same email address. The partner ecosystem platform 102 can determine that a match exists when an account record of a first partner has a domain name that matches an email domain, e.g., “example.com” matches “jsmith@example.com” of a lead record of a second partner.

The determination of contextual record overlaps by the partner ecosystem platform 102 can be enabled by how match time is calculated and displayed. When a record meets the definition criteria for a population, the partner ecosystem platform 102 can determine that the record has made a population “entry.” Conversely, if the record later changes and no longer meets the definition criteria for the population, that is treated as population “exit.” The partner ecosystem platform 102 can determine, capture, and store contextual data, e.g., movement data, representing these entrances and exits. Such data can be valuable in characterizing the movement and change over time of the record data of partners. Similarly, the partner ecosystem platform 102 can determine, capture, and store contextual data, e.g., match data, when a record starts or stops overlapping with a partner record. Movement data can include a match time at which a movement into, between, or out of population(s) occurred.

Every time a record enters a population, the partner ecosystem platform 102 can persist movement data representing the entry as an entrance event in a backend server. A record would enter a population either because the underlying CRM data changed and it now satisfies the population definition criteria, or because the population definition criteria changed in a way that the record now satisfies those criteria. Every time a record exits a population, the partner ecosystem platform 102 can persist movement data representing the exit as an exit event in the backend server. A record would exit a population either because the underlying CRM data changed and it no longer satisfies the population definition criteria, or because the population definition criteria changed in a way that the record no longer satisfies those criteria, or because the population was removed. In both of the above cases, movement data can be persisted for entry and exit of records in populations regardless of whether the record overlaps with a partner record.

In addition to movement data, the partner ecosystem platform 102 can persist match data. Every time a record overlaps with a partner record, the partner ecosystem platform 102 can persist match data in the backend server. If sharing settings on a population change and a record in that population is newly overlapping with a partner record, then that is also considered as an overlap event. Every time a record stops being an overlap with a partner record, either because CRM data changed, the population definition criteria on either side of the partnership changed, or the data that made the match a match changed, e.g., the domain changed, then the partner ecosystem platform 102 can persist match data representing the overlap exit event in the backend system. Match data can include match times at which overlap changes occurred.

The captured movement data and match data representing record movement events and record overlap events can be stored in the backend server for presentation as a time series at the individual record level. The time series can be presented in chronological order to allow a partner to see when a record entered or exited a population, or started or stopped overlapping a partner record. Such record movement and overlaps can be seen on either side of the partner relationship.

The partner ecosystem platform 102 can calculate movement data and match data in response to movement or overlaps occurring and, thus, population movement entry/exit events and overlap entry/exit events are known immediately upon calculation. Accordingly, the partner ecosystem platform 102 can rapidly notify partners on either side of the partner relationship, or trigger automations allowing reaction to potentially significant business events.

It will be appreciated that the partner ecosystem platform 102 provides standard pre-defined populations that model a typical sales funnel across the standard populations, e.g., from prospect to open opportunity to customer. By tracking the population movement of accounts through the funnel for both a first partner and a second partner, the first partner has visibility to the effectiveness of the partnership as measured by the volume and speed of movement of accounts through the sales funnel. The first partner may also have visibility to an outcome of the record, e.g., whether the opportunity closed and was won or lost.

The partner ecosystem platform 102 can use a data model in which opportunities records are related to accounts with a many to one relationship. An account can be a type of record. An opportunity record can be used to track a specific commercial opportunity, and the revenue attached to that opportunity. An account can have any number of opportunities records. Opportunities records contain a status field and that field can provide important context on the opportunity. Status can include stages of an opportunity and opportunities records can be considered “open” or “closed.” If opportunities records are “open,” they may exist in one of the stages, and if they are “closed” they are generally “closed/won” or “closed/lost.” Closed/won status can correspond to the account now being a customer or expanding or renewing their relationship with the company. Closed/lost status can mean that the specific opportunity was lost, which could mean a contraction or churn or simply a lack of attempted expansion of the account. Population definitions can include some of the context from opportunities in them. Opportunity fields can be used to filter down or define populations as well.

When a record enters an open opportunity population, the partner ecosystem platform 102 may determine that an opportunity is now open. When a record enters a customer population, the partner ecosystem platform 102 may determine that the opportunity went from being open to closed/won. Such determinations based on opportunity context of record overlaps is not exhaustive, however, Fields for record overlap context from opportunity records can include status fields, owner fields, or other fields. If either the status field or the owner field changes, it can trigger new notifications or workflows. It will also be appreciated that the context provided by the status fields and owner fields can provide equally useful context as other forms of context described above.

Examples of notifications based on opportunity status context include sending a message to a first partner, when one of their own opportunities changes state, if the first partner talked to a second partner about that account. The message can ask whether the second partner is related to the opportunity stage change, e.g., to confirm whether the second partner was indeed helpful in moving the opportunity along for the first partner. Additionally or alternatively, recently won and new opportunity notifications can be sent from a partner based on opportunity fields that the partner is sharing. Such notifications can be shown in a user interface and collected for a weekly email or alerted on instantly.

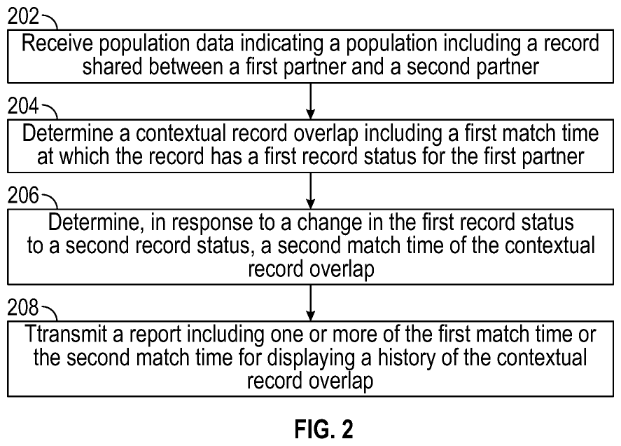

Referring to FIG. 2, a flowchart of a method of determining a contextual record overlap is shown in accordance with an embodiment. In view of the above description of how population data can be segmented, shared, and matched to determine overlap data and/or match data, an example of using contextual record overlap data to perform an action by the partner ecosystem platform 102 is now described. At operation 202, population data is received. The population data can indicate several populations, e.g., a first population for a first partner and a second population for a second partner, including a record shared between a first partner and a second partner. The population can be segmented data having various criteria. For example, the population data can indicate accounts as target accounts, prospects, customers, etc., for the first partner and the second partner.

At operation 204, a contextual record overlap is determined. The partner ecosystem platform 102 can determine whether records imported from the data sources are matches. The contextual record overlap can include a first match time at which the record has a first record status for the first partner. For example, the first match time can be a time at which the account was first entered or shared by the partner, and identified as having a particular status. The status can be, for example, which population segment of the partner the account resides within, e.g., within a prospect population segment.

At operation 206, a second match time of the contextual record overlap can be determined. As described above, over time, the account may move into or out of the population segments. For example, an account may initially be a prospect for a partner and then later become a customer for the partner. The second match time determination may be in response to a change in the first record status to a second record status. For example, the second match time can be when the account changes from being part of a prospect population segment for the partner to being within a customer population segment for the partner.

At operation 208, a report is transmitted to provide visibility to the overlap within different partner populations and/or movement of the account from one population to another of one of the partners. The partner ecosystem platform can generate, for presentation on a display of the computing system, report data including one or more of the first match time and the second match time. Accordingly, as described below, the report data can be used to display a history of the statuses of the record. That is, a history of the contextual record overlap can be displayed.

Display of the contextual record overlap and the movement of the overlap from population to population can be made in a variety of user interfaces. The reporting of such movement allows partners to collaborate on new overlaps, e.g., shared records, as the overlaps occur. A notification can be surfaced to users to alert to an occurrence of an overlapping opportunity with a partner. By way of summary, the movement can surface in multiple places in the system, including: alongside records as a column in a table of overlapping records; on an activity timeline user interface; on an individual record page user interface; via notifications that may be sent via: in-app in a notification center; a messaging application; email; a CRM application; etc. It is noted that an external API of the system can include field(s) that can be used to power use cases outside of the system. Such reporting can be made as soon as an overlap is identified. Accordingly, timely updates about overlaps and changes in the context of record overlaps can be provided to a user. Furthermore, the updates can allow a user to see a status of the record as it moves from population to population, rather than seeing a static overlap indication that does not take such changes into account. The partners can, in response to the notifications, collaborate on new shared overlaps as the overlaps occur.

As described below, an activity timeline is one display mode for presenting events associated with records that overlap between populations. The activity timeline can show historical contextual record overlap details. The activity timeline can contain the context for all record overlaps and may be displayed by the partner ecosystem platform 102 to satisfy different use cases. Different views of the activity timeline may be filtered down on different dimensions. Several examples follow.

In an embodiment, the activity timeline may be displayed without filtering. More particularly, all records may be displayed in an activity timeline of activity across all partners, e.g., Partners A, B, C, etc.

In an embodiment, the activity timeline may be filtered down on a specific record. In such case, filtering can cause the display in an activity timeline of all activity that is attached to any given record overlap. This can include Partner A's activity as well as partners of Partner A, e.g., Partner B, C, etc. Some activity of the partners of Partner A, e.g., Partner B, C, etc., can be hidden from partner A based on security/privacy and data sharing, but things like movement from one population of Partner B to another population of Partner B can be displayed on the activity timeline for Partner A to view. Notably, the activity timeline can be further filtered down by other dimensions, e.g., to include activity of only certain partners or use cases.

In an embodiment, the activity timeline may be filtered down on a specific partner. Filtering can cause the display of all activity for any given partner of Partner A. The activity timeline could optionally include activity, or exclusively contain data, from Partner A, or not, based on filtering available in the user interface. Filtering may be applied to all records or for a specific record.

In an embodiment, the activity timeline may be filtered down on a specific use case. The filtering can cause the display of an activity timeline including activity relevant to determining attribution across Partners A, B, C, etc. Attribution is a process by which a specific opportunity is “credited” to a specific entity, action, or event. Such attribution events can be displayed for a specific record, or may be displayed for all records. In an embodiment, the specific use case can be shared lists. More particularly, the activity timeline can be filtered down to show activities that happened within a shared list. The activity timeline can include a view of select records that is curated by Partner A and Partner B. Alternatively, the activity timeline can be filtered down to a notes use case. The notes use case can include presentation of activity timeline events that include notes that were entered into a shared list on a given record, or other shared list or specific data.

It will be appreciated that context exists for record overlaps outside of population definitions, and can come from external systems via integrations. For example, call recording software can generate context data indicating whether and when a call has or has not happened with a specific partner. Similarly, instant message services can generate context data indicating whether messages were sent between partners. CRM applications can generate context data that can update values on standard fields that will show up as activities. Any such context data generated by integrations can be captured and stored by the partner ecosystem platform 102 for use in displaying on activity timelines.

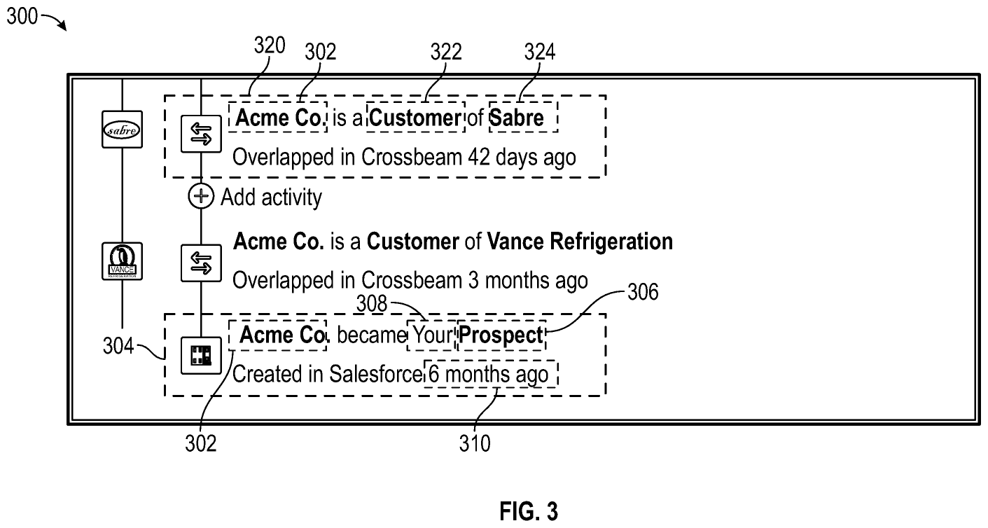

Referring to FIG. 3, a pictorial view of an activity timeline 300 indicating a contextual record overlap is shown in accordance with an embodiment. The activity timeline 300 may be displayed by a computing system. The contextual record overlaps described herein can be used as an input to an activity timeline 300. Such activity timelines 300 may be a feature of a partner influence engine, which is described in U.S. patent application Ser. No. 17/971,434, the contents of which are incorporated herein in their entirety.

An activity timeline 300 can show historical contextual record overlap details at one or more match times. In an embodiment, the activity timeline 300 can include a view of record overlaps that are filtered down to a specific record. For example, the specific record associated with events displayed in the activity timeline 300 can be a first record 302.

The activity timeline 300 can include a timeseries of movement events represented by movement data. For example, first movement data 304 can indicate when the first record 302 moved into a first population 306 of a first partner 308. The movement data can be associated with a first movement time, which can be a match time 310 at which the partner ecosystem platform 102 determined that the first record 302 was added to the first population 306 of the first partner 308 (e.g., 6 months ago). The first record 302 can be identified in the activity timeline 300 by a Record ID, e.g., “Acme Co.” Similarly, the first population 306 can be identified by a Population ID of the first partner 308, e.g., “Prospect.”

The first record 302 can be an overlap or match between several partners. Accordingly, in the particular activity timeline 300 view generated by the partner ecosystem platform 102, the first record 302 can be represented in second movement data 320. The second movement data 320 can represent movement of the first record 302 into a second population 322 of a second partner 324. Similar to the first movement data 304, the population can be identified by a Population ID, but in this case, by a Population ID of the second partner 324, e.g., “Customer.” Furthermore, the contextual record overlap can include a Partner ID identifying the second partner 324, e.g., “Sabre.” The movement data can include a second match time at which the partner ecosystem platform 102 determines that the record moved into the second population 322. More particularly, the movement is shown to have occurred 42 days ago on the activity timeline 300. The first record 302 can be identified in the second movement data 320 by the same Record ID as shown in the first movement data 304.

One or more additional movement events may be represented on the activity timeline 300 for the contextual record overlap. For example, a third movement data, intermediate to the first and second movement data 320, is shown in FIG. 3. The intermediate movement data indicates when the first record 302 obtained a status, e.g., Customer, for a third partner, e.g., Vance Refrigeration.

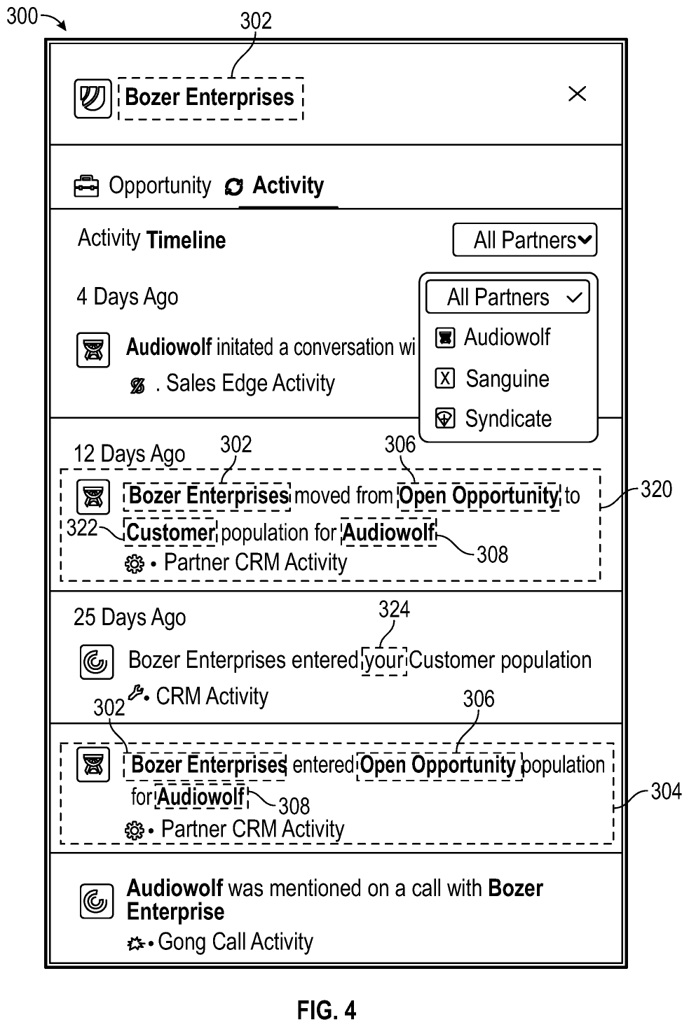

Referring to FIG. 4, a pictorial view of an activity timeline 300 indicating a contextual record is shown in accordance with an embodiment. The activity timeline 300 can show a context for a first partner 308 and a second partner 324 for a record overlap. The activity timeline 300 can represent an alternative representation of a specific record, as compared to FIG. 3. More particularly, the activity timeline 300 can represent movement of a first record 302 (identified by a Record ID “Bozer Enterprises” in this case).

Similar to the activity timeline 300 of FIG. 3, the activity timeline 300 of FIG. 4 can represent the contextual record overlap of one or more partners. Additionally, the activity timeline 300 can show a change in status of the record. More particularly, the activity timeline 300 can show movement data indicating movement of the first record 302 between populations of a same partner.

In an embodiment, the activity timeline 300 can include first movement data 304 indicating when the first record 302 entered a first population 306 (e.g., the open opportunity population) for a first partner 308, e.g., Audiowolf. The activity timeline 300 may include additional movement data, e.g., second movement data 320, indicating the first record 302 moved from the first population 306 of the first partner 308 to a second population 322 of the first partner 308 (e.g., the customers population). The movement of the first record 302 into or within populations of other partners, as well as integration data associated with the first record 302 may also be represented in the activity timeline 300. Accordingly, the timeline can provide a visual history of the record movement between populations for the first partner 308 and the other partners, as well as other historical events that can be actionable.

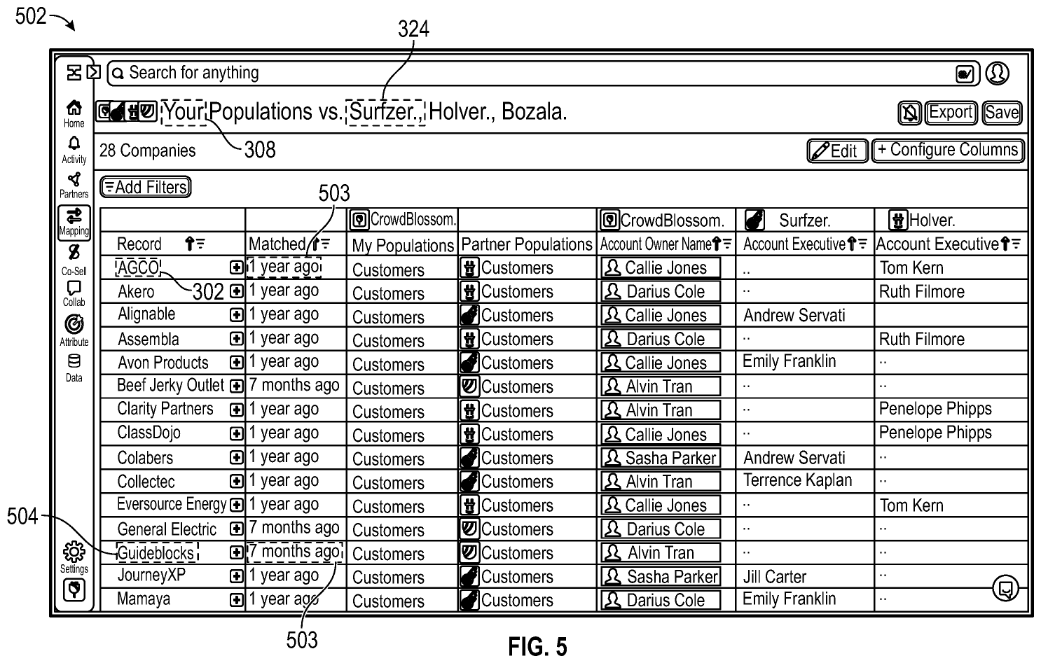

Referring to FIG. 5, a pictorial view of a report indicating a contextual record overlap is shown in accordance with an embodiment. The report can show an account mapping 502 having several partners and several populations.

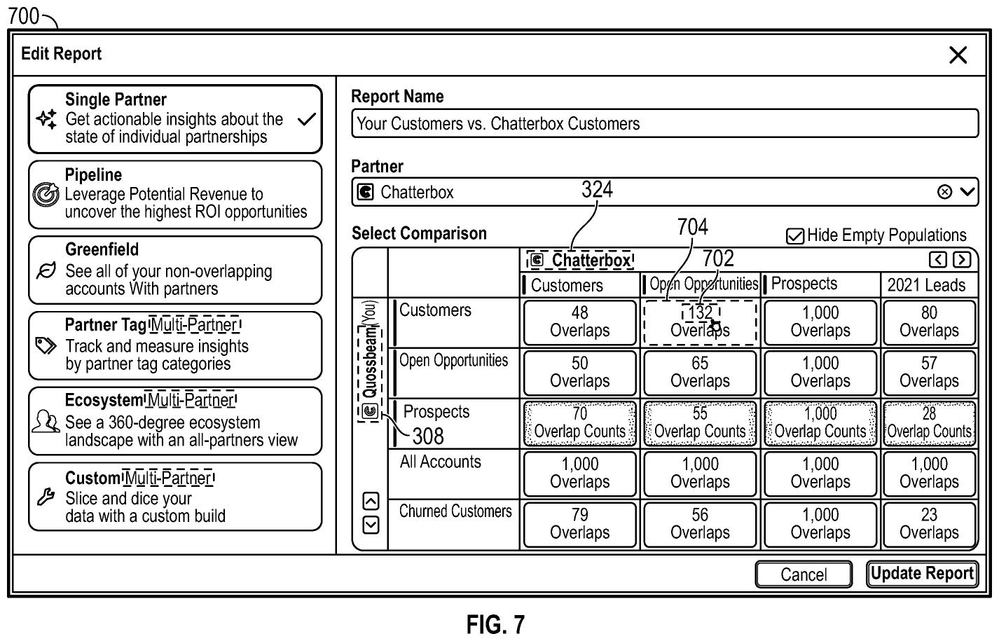

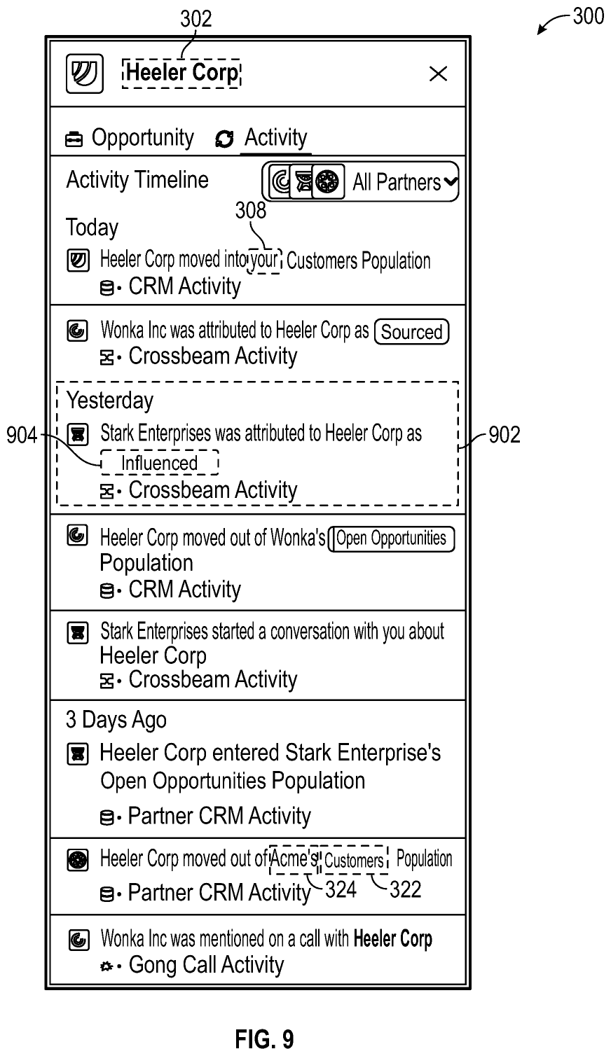

When one partner account maps with another partner, they are running a comparison from one or more of their own populations to one or more populations of their partner. The output can be a list of records that overlap and exist within the specific context of the selected populations. Account mappings 502 can be run on their own by defining populations and partners and partner populations for viewing. An account mapping 502 may be viewed by clicking into any given cell of an account mapping matrix (FIGS. 7 and 9). Similar to the account mapping matrix, the context of the various records can align with a specific use case that a partner is pursuing.

An account mapping 502 can include a report showing all of the overlaps of the record based on established contexts. More particularly, the user can select several partners, e.g., a first partner 308 and a second partner 324, for comparison as the context against which the record overlaps are reported. For example, the first partner 308 (e.g., your organization) can be compared to one or more other partners, e.g., “Surfzer,” “Holver,” “Bozala,” etc., as the context for visualizing the record overlaps. The report can then identify the overlap for various records between the identified partners. The overlap can be determined by the match time 503 associated with the overlap. For example, if “AGCO” is a shared first record 302 for the first partner 308 and the other selected partners, and the record moved between populations of any of the partners at a time, the report would then identify that match time 503, e.g., “1 year ago.” Similarly, if “Guideblocks” is a shared second record 504 for the first partner 308 and the other selected partners, and the record moved between populations of any of the partners at a time, the report would then identify that match time 503, e.g., “7 months ago.” Notably, the overlaps can be sorted by the match time to show the most recent overlaps.

The account mapping 502 can include a listing of the shared records. For each shared record, the account mapping 502 may also include information about the populations that the shared record resides in for each partner and/or a name of an account owner (or executive) of one or more of the partners. The account mapping 502 may also include any other fields that may be relevant that have been synchronized into the partner ecosystem platform 102. Additional information, such as contact information for the account owner(s) may be surfaced through the account mapping 502. Accordingly, a sales representative of the first partner 308 can be notified by the report that an overlap exists, which could lead to collaboration, and the sales representative can reach out to the account owner at a partner to initiate the collaboration.

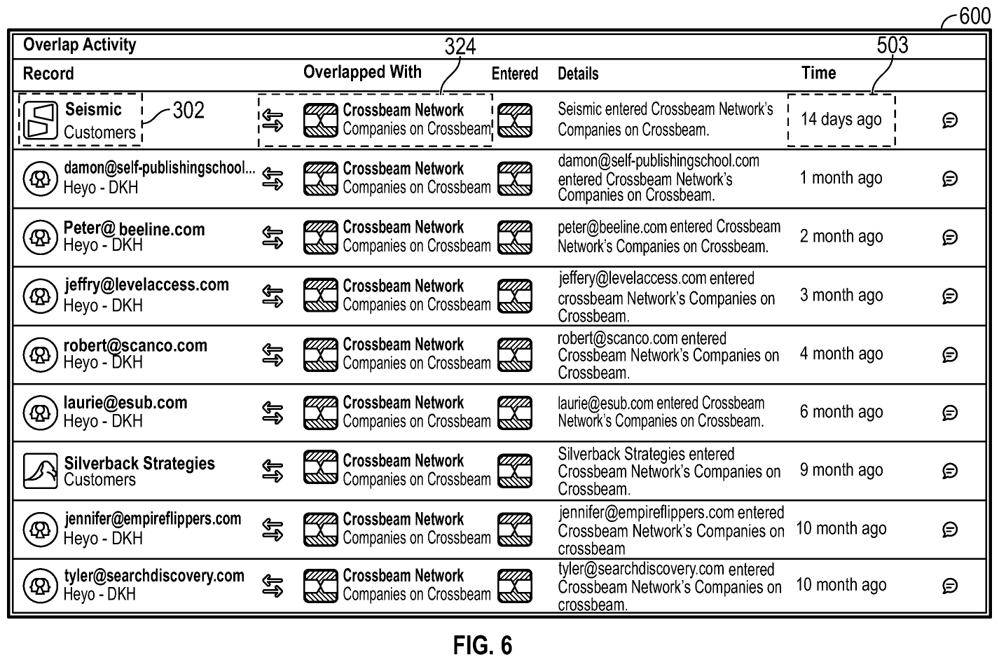

Referring to FIG. 6, a pictorial view of a feed 600 indicating a contextual record overlap is shown in accordance with an embodiment. A feed 600 can be a display mode that presents a running feed 600 of overlaps that occur in time. The feed 600 can include the most recent match times 503 shown at a top of a list. As new overlaps or movements of overlapping records occur, the top entry would move down the list to be superseded by the more recent records being listed above.

In an embodiment, a first record 302 for a first partner 308 is determined to overlap with, e.g., be in a population of, a second partner 324. The feed 600 can include additional records that overlap with partners of the first partner 308. In FIG. 6, the feed 600 can be filtered down to only show events corresponding to records overlapping with the second partner 324, however, the feed 600 could be expanded to also include overlaps with additional partners. In any case, the feed 600 can include a match time 503 at which the overlap is determined to have occurred, e.g., “14 days ago.”

Referring to FIG. 7, a pictorial view of an activity mapping matrix indicating contextual record overlaps between partners is shown in accordance with an embodiment. The visualization of a single point in time of all overlapping records in the context of two partners can be visualized in an account mapping matrix 700. The account mapping matrix 700 can show a count 702, per cell, of how many records exist in the stated context of two partners. For example, the cell can show the count 702 of overlaps between the corresponding first population of the first partner and the second population of the second partner.

In an account mapping matrix 700 for only standard populations (prospects, open opportunities, and customers), there are nine cells. The cells represent overlapping records between a first partner 308 (also referred to as “Partner A”) prospect records and a second partner 324 (also referred to as “Partner B”) prospect records, Partner A prospect and Partner B open opportunities records, Partner A prospect records and Partner B customers records, Partner A open opportunities records and Partner B prospect records, Partner A open opportunities records and Partner B open opportunities records, Partner A open opportunities records and Partner B customers records, Partner A customers records and Partner B prospect records, Partner A customers records and Partner B open opportunities records, and Partner A customers records and Partner B customers records.

The cells represent overlapping records by defining how many of one population are also in another population. For example, a value in a matrix cell 704 representing overlapping records between Partner A customers records and Partner B open opportunities records can indicate the count 702 (how many) of customers of Partner A that are currently open opportunities of Partner B. Such visualization allows users of the partner ecosystem platform 102 to target a specific use case that applies to a specific contextual cell. For example, two partners may have an integration with each other, and the partners can readily identify overlapping customers that the partners may want to target to advertise the integration to, in order to increase usage of the integration. Another example would be visualization that identifies overlaps in which Partner B may ask Partner A for intel or information on a specific open opportunity that is also a customer of Partner A so that Partner B can move the opportunity forward.

The account mapping matrix 700 can include custom populations. For example, populations of Partner A can include “All Accounts” and “Churned Customers,” and populations of Partner B can include “2021 Leads.” Accordingly, a number of cells displayed in an account mapping matrix 700 can be calculated by a number of populations for Partner A times a number of populations for Partner B (that are visible to the viewing partner based on sharing rules).

The matrix cell 704 may be selectable. More particularly, the computing system can receive a user selection of the matrix cells 704 in the account mapping matrix 700. In response to receiving a selection of an account mapping matrix 700 cell, the computing system can display an account map. For example, clicking into a cell of the account mapping matrix 700 that represents overlaps between Partner A customers and Partner B open opportunities can cause the display of an account map (FIG. 5). More particularly, the account map displayed in response to selection of the matrix cell 704 can include a listing of the 132 overlap records associated with the selected cell. The account mapping view can include the display of additional information, as shown in FIG. 5, such as an account owner name and/or an account executive associated with the overlap record. Accordingly, the account mapping matrix 700 can provide a visualization of population overlaps that can be actionable. If data is being shared, there is the possibility that the partner is only sharing the number of overlaps but not the overlap data itself, such as the company name, etc. In such case, the viewer may not be able to click into a cell and see the summary of overlaps in the cell.

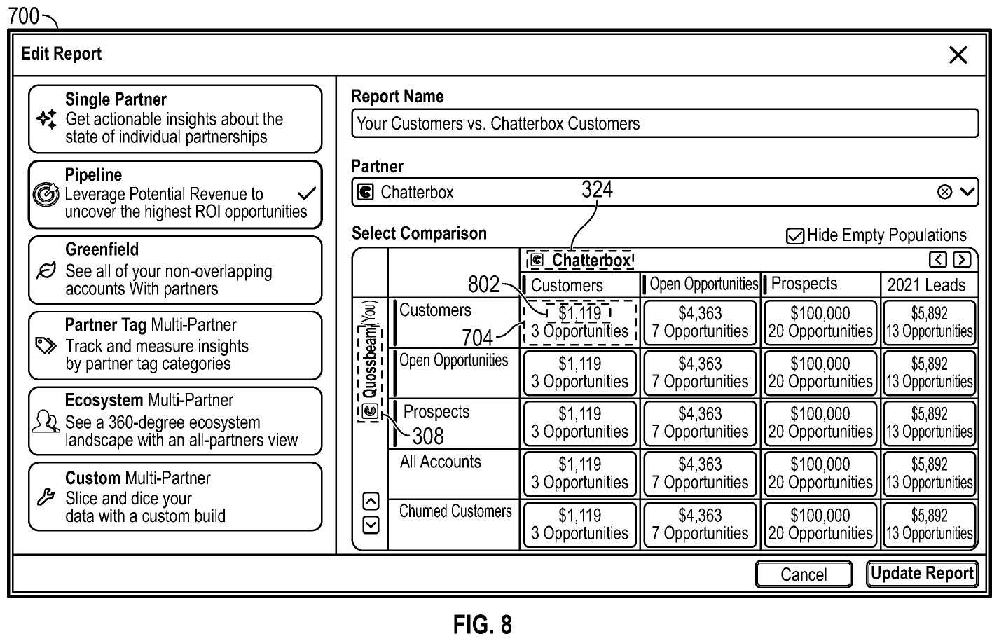

Referring to FIG. 8, a pictorial view of an activity mapping matrix indicating revenue totals of contextual record overlaps between partners is shown in accordance with an embodiment. Revenue totals may be for potential revenue, which is the potential value of the opportunity that is pulled from a (configurable) field on the opportunity. For example, the field may be an amount field. It is noted that the value may not confirmed as the final revenue until the opportunity is closed. The account mapping matrix 700 may include matrix cells 704 that include revenue totals corresponding to the overlapping populations of the partners. More particularly, the revenue totals can be for opportunities that are attached to any given overlapping record. A cell can show the revenue of overlaps between the corresponding first population of the first partner and the second population of the second partner. For example, the account mapping matrix 700 can indicate that a revenue 802 of overlapping customer accounts for the first partner 308 and customer accounts for the second partner 324 is $1,119. This information may or may not prompt a sales representative of Partner B to seek information from Partner A. More particularly, the information may cause a partner to target a specific motion with another partner based on the revenue that they could potentially gain from targeting accounts in a given cell on the account mapping matrix.

The matrix cell 704 may be selectable. In response to receiving a selection of an account mapping matrix 700 cell, the computing system can display an account map. The account map displayed in response to selection of the matrix cell 704 containing total revenue 802 (versus overlap count 702) can include a listing of the records associated with the selected cell and the corresponding revenue 802 from each record. Accordingly, the account mapping matrix 700 can provide a visualization of population overlaps that can be actionable.

Referring to FIG. 9, a pictorial view of an activity timeline 300 indicating an attribution event is shown in accordance with an embodiment. An activity timeline 300 can show an attribution event, e.g., attribution was specifically marked on an account for a partner. In an embodiment, attribution can be marked in a side panel of a message if a partner thinks another partner deserves attribution for the communication. As described above, attribution is a process by which a specific opportunity is “credited” to a specific entity, action, or event. Opportunities can have multiple sources of attribution, depending on an organization's policies and processes. Partner attribution, more specifically, is when a partner is credited for having an impact on an opportunity. This may be defined differently by different organization, but traditionally fits into two main categories: sourced attribution and influenced attribution. Sourced attribution means that the opportunity was generated by a partner (e.g., sent to a first partner 308 by a second partner 324 or an introduction from the second partner 324 created the opportunity. Influenced attribution means that some form of intel, introduction, or other assistance from the second partner 324 helped close an existing open opportunity for the first partner 308.

Partner attribution is an important use case for contextual record overlaps because the information derived from the current and historical context of a specific record overlap can determine and/or inform attribution decisions. For example, if an opportunity, at the time of being opened, has partner(s) overlap(s) with the record, then the partner(s) are possibly more likely to have influenced the opportunity than partners who do not have the underlying record as a customer. The partner ecosystem platform 102 can therefore determine that attribution is likely to have occurred, and recommend attribution based on the context of the record overlaps.

Inside a CRM, an opportunity record is used to track a specific commercial opportunity, and the revenue anticipated or won from that opportunity. Users of the partner ecosystem platform 102 can view and filter all of their opportunities records as defined in their CRMs. They can select an opportunity record and attribute a specific partner as having sourced or influenced that revenue 802. The partner ecosystem platform 102 can identify opportunities records with a high likelihood of attributable source/influence. For example, the partner ecosystem platform 102 can determine, based on a recent closed times of an opportunity record along with overlaps and other activities, that source or influence is likely. The likelihood can be highlighted for users to prioritize when attributing. All attributions can be persisted to the backend server can be viewable across all users on a partner account that is attributing. Attributions may not be visible to users of another partner account that is being considered for attribution. The partner ecosystem platform 102 can allow users to analyze their attributions using pre-built metrics, e.g., total influenced/sourced revenue, time to close with/without partners, etc. Users can choose which metrics to show/hide on an attribution dashboard.

In an embodiment, the activity timeline 300 can show a context for a first partner 308 and a second partner 324 for a record overlap. The activity timeline 300 can represent an alternative representation of a specific record, as compared to FIGS. 3 and 4. More particularly, the activity timeline 300 can represent not only movement of a first record 302 (identified by a Record ID “Heeler Corp” in this case) into, within, or out of populations of various partners. The activity timeline 300 can also include one or more attribution indicators 904. For example, the partner ecosystem platform 102 can determine that attribution occurred and display the activity timeline 300 that includes attribution data 902 including an attribution indicator 904. The attribution indicator 904 can indicate that a partner (Stark Enterprises in this case) was attributed to the first record 302 as influenced. More particularly, it is evident from the activity timeline 300 that the attribution data 902 indicates that Stark Enterprises started a conversation with the first partner 308 about the first record 302 and, thus, the partner ecosystem platform determined that Stark Enterprises influenced the movement of the record into a population segment, e.g., customers, of the first partner 308. Attribution may be displayed in response to such determination, automatically, or the partner ecosystem platform 102 may recommend that attribution be indicated and the partner(s) may be allowed to confirm the attribution before presenting the attribution indicator 904. Accordingly, the activity timeline 300 can provide a visualization of attribution events.

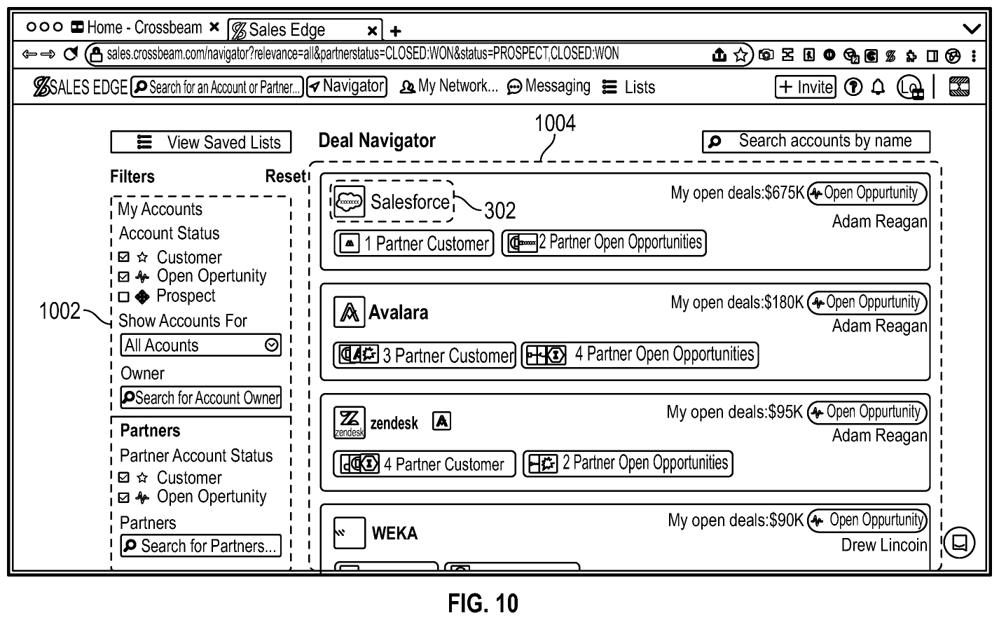

Referring to FIG. 10, a pictorial view of a report indicating contextual record overlaps of several partners is shown in accordance with an embodiment. A display mode can include a display of context for specific records based on context filtering. For example, in a context filter portion 1002 of the user interface, a user may select populations for display.

A deal navigator view 1004 can display an alternative account map. The deal navigator view 1004 can include a list of accounts that meet the filter criteria entered in the context filtering. For example, customer and open opportunities populations are selected for Partner A in the context filter portion 1002 of the display mode. Similarly, customer populations are selected for Partner A in the context filter portion 1002. Accordingly, accounts that are in the customer and open opportunities populations of Partner A and the customer populations of Partner B can be listed in the deal navigator portion of the user interface. The additional information about the accounts, such as the populations it belongs to, can also be displayed

As an example, a first record 302 can be displayed indicating an account in an open opportunity population of a first partner 308. The deal navigator portion can indicate a number of partners that include the first record 302 in a customer population. Accordingly, the deal navigator portion provides an account map showing overlaps of the listed records.

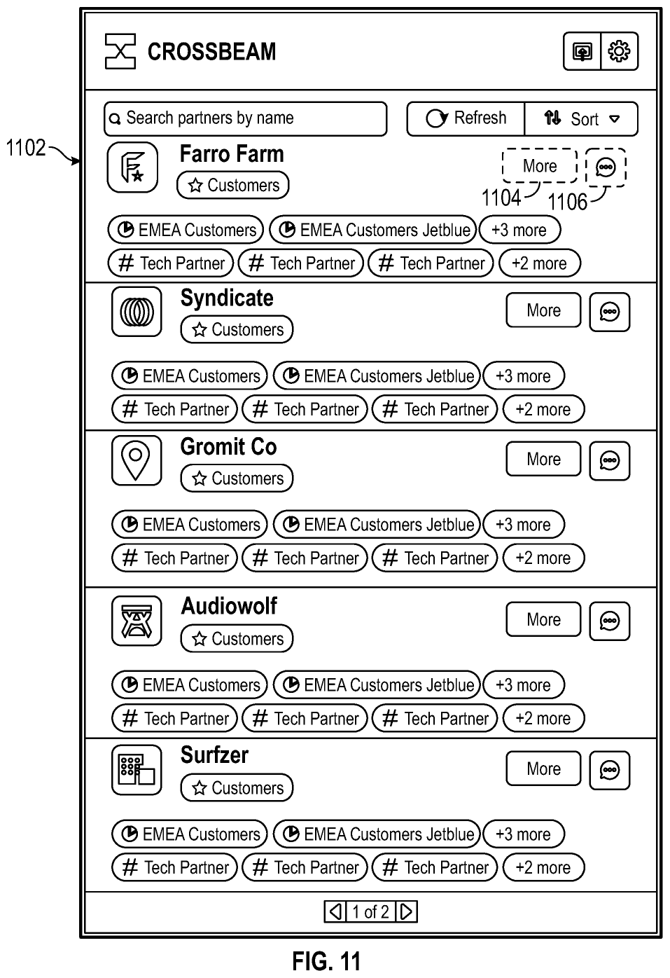

Referring to FIG. 11, a pictorial view of actionable contextual record overlaps is shown in accordance with an embodiment. A record overlap context can be displayed within a widget 1102 of a CRM application. The display can allow sales representatives to take action based on the record overlap context.

The widget 1102 in a CRM application can show partners having overlaps for a particular account. The widget 1102 can live on an account, e.g., Jetblue, in the CRM application. For example, a first record 302, e.g., a company named “Jetblue,” may be selectable in the CRM application to launch the widget 1102. The widget 1102 can then list partners that also have the first record 302 in one or more of their populations. In the listing shown in FIG. 11, all of the partners, e.g., Farro Farm, Syndicate, Gromit Co, etc., have the selected first record 302 in their customers populations.

The widget view can allow for actions to be taken. Actions can include providing more details on overlaps, or messaging a partner with the overlap. For example, selection of a more details element 1104 in the user interface can reveal, through an additional display portion, any data about the first record 302 that has been shared by the partner, e.g., Farro Farm. Similarly, a messaging element 1106 may be selectable by a user interaction to cause a messaging application to launch. The messaging application may then be used to send a message to the partner, for example, to request collaboration or information regarding the first record 302.

The widget 1102 described above is one example of an integration. The partner ecosystem platform 102 can have various other integrations with CRM applications, data warehouses, as well as an API. All of these integrations can allow a partner to pull contextual record overlaps out of the partner ecosystem platform 102 for display in the external systems. For examples, in a CRM application, a widget 1102 and a custom object can both provide record overlap context to sales representatives within the CRM application. The record overlap context can allow the sales representative to decide how to leverage their various partners based on the context of the overlapping record. In an embodiment, a data warehouse integration can be used. The partner ecosystem platform 102 can push out record overlaps with context that are transformed into a dashboard that provides the contextual record overlaps to sales representatives within the data warehouse or to an integrated analytics tool. the record overlap context can allow the sales representatives to decide how to leverage their various partners based on the context of the overlapping record. In an embodiment, the partner ecosystem platform 102 can have an API integration. the integration can allow contextual record overlaps to be pulled from the partner ecosystem platform 102 to be used and displayed in any external system.

Contextual record overlaps identified by the partner ecosystem platform 102 can, in addition to certain display modes as described herein, cause the partner ecosystem platform 102 to initiate actions or send notifications. More particularly, the changing context of a given record overlap can trigger a specific workflow or notification.

When a given record is no longer a member of, for example, the prospect population and becomes a member of the open opportunity population, it can mean that a new opportunity was opened on the account attached to the opportunity. The existence of context from various partners on this record could impact the downstream workflows that are triggered. For example, a notification trigger or a change in workflow can be generated.

In an embodiment, a notification trigger is generated. When an account moves from one population to another, for example, (this could apply to other contexts changing as well), a notification may be sent to the owner of the opportunity to let them know the context of the partners on the record (account attached to the opportunity). When a given record overlap emerges, if it is for an existing open opportunity, the owner of the opportunity may be alerted to let them know there is context from a partner that could help them close their opportunity. Daily emails can be sent if a partner has new (records) accounts or new opportunities assigned to them (based on the context). The email can contain information about the partners that can help (based on the partner context) to allow the partner to reach out to the potentially helpful partners.

In an embodiment, a change in workflow is triggered. When a record overlap changes context, different workflows may be triggered depending upon the content that exists on the record overlap. For example, if no partners have the given record (account attached to the opportunity) as a customer, then a specific workflow may be triggered. However, if one or more partners do have the given record (account attached to the opportunity) as a customer, then a different workflow (that includes contacting those partners), may be triggered.

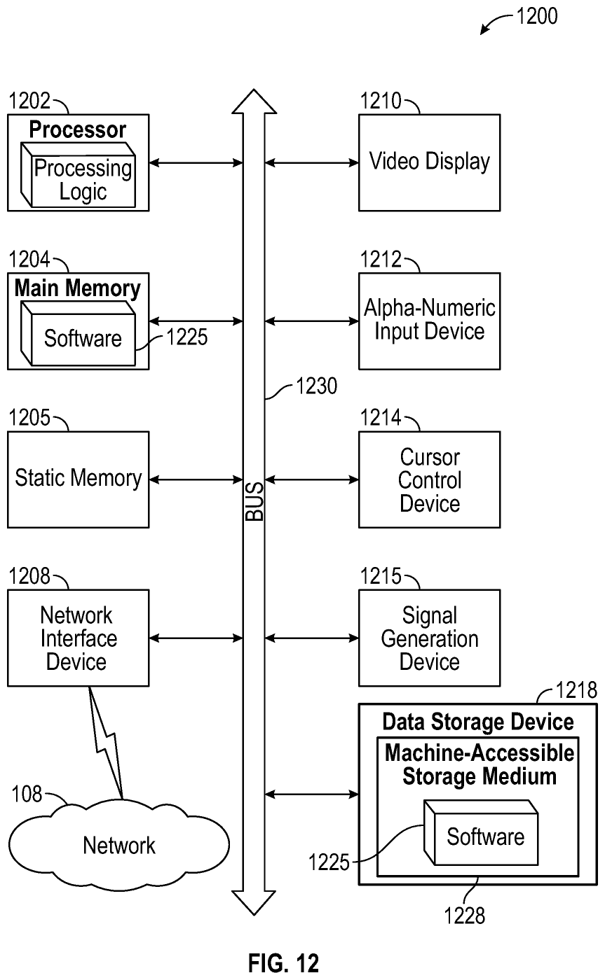

Referring to FIG. 12, a block diagram of an example computing system that may perform one or more of the operations described herein is shown in accordance with some embodiments. More particularly, computing system 1200 may be integrated in any of the servers and/or devices described above to perform any of the described operations. Computing system 1200 may be connected to other computing devices in a LAN, an intranet, an extranet, and/or the Internet. The computing system may operate in the capacity of a server machine in the client-server network environment or in the capacity of a client in a peer-to-peer network environment. The computing system may be provided by a personal computer (PC), a set-top box (STB), a server, a network router, switch or bridge, or any machine capable of executing a set of instructions (sequential or otherwise) that specify actions to be taken by that machine. Further, while only a single computing system is illustrated, the term “computing device” or “computing system” shall also be taken to include any collection of computing devices that individually or jointly execute a set (or multiple sets) of instructions to perform the methods discussed herein.

The example computing system 1200 may include one or more processing devices (e.g., a processing device, a general purpose processing device, a PLD, etc.) 1202, a main memory 1204 (e.g., synchronous dynamic random access memory (DRAM), read-only memory (ROM)), a static memory 1205 (e.g., flash memory and a data storage device 1218), which may communicate with each other via a bus 1230.

The one or more processing devices 1202 may be provided by one or more general-purpose processing devices such as a microprocessor, central processing unit, or the like. In an illustrative example, processing device(s) 1202 may comprise a complex instruction set computing (CISC) microprocessor, reduced instruction set computing (RISC) microprocessor, very long instruction word (VLIW) microprocessor, or a processing device implementing other instruction sets or processing devices implementing a combination of instruction sets. Processing device(s) 1202 may also comprise one or more special-purpose processing devices such as an application specific integrated circuit (ASIC), a field programmable gate array (FPGA), a digital signal processor (DSP), network processor, or the like. The processing device(s) 1202 may be configured to execute the operations described herein, in accordance with one or more aspects of the present disclosure, for performing the operations and steps discussed herein.

Computing system 1200 may further include a network interface device 1208 which may communicate with a network 108. The computing system 1200 also may include a video display unit 1210 (e.g., a liquid crystal display (LCD) or a cathode ray tube (CRT)), an alphanumeric input device 1212 (e.g., a keyboard), a cursor control device 1214 (e.g., a mouse) and an acoustic signal generation device 1215 (e.g., a speaker). In one embodiment, video display unit 1210, alphanumeric input device 1212, and cursor control device 1214 may be combined into a single component or device (e.g., an LCD touch screen).

Data storage device 1218 may include a computer-readable storage medium 1228 on which may be stored one or more sets of instructions 1225 that may include instructions for carrying out the operations described herein, in accordance with one or more aspects of the present disclosure. Instructions 1225 may also reside, completely or at least partially, within main memory 1204 and/or within processing device(s) 1202 during execution thereof by computing system 1200, main memory 1204 and processing device(s) 1202 also constituting computer-readable media. The instructions 1225 may further be transmitted or received over a network 1220 via network interface device 1208.

While computer-readable storage medium 1228 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding, or carrying a set of instructions for execution by the machine and that cause the machine to perform the methods described herein. The term “computer-readable storage medium” shall accordingly be taken to include, but not be limited to, solid-state memories, optical media, and magnetic media.

In the foregoing specification, the invention has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A method, comprising:
receiving, by a processing device of a computing system, population data representing respective population segments of a first partner and a second partner, wherein the respective population segments include a record overlapping between the first partner and the second partner;
determining, by the processing device, a first match time at which the record has a first record status for one of the partners;
determining, by the processing device, in response to a change in the first record status to a second record status for one of the partners, a second match time of the record; and
generating, to present on a display of the computing system, report data including the first match time and the second match time, wherein the report data representing a history of the record statuses.

2. The method of claim 1 further comprising determining, by the processing device, an overlap of the record between the first partner and the second partner.

3. The method of claim 2, wherein determining the overlap includes determining the record has a same domain name in the respective population segments of the first partner and the second partner.

4. The method of claim 1, wherein the change in the first record status to the second record status includes movement of the record from a first population segment of the first partner to a second population segment of the first partner.

5. The method of claim 1, wherein the change in the first record status to the second record status includes movement of the record from a first population segment of the second partner to a second population segment of the second partner.

6. The method of claim 1 further comprising displaying, by the display, the report data in an activity timeline indicating movement of the record into the respective population segments of the first partner and the second partner.

7. The method of claim 1 further comprising displaying, by the display, the report data in an activity timeline indicating movement of the record from a first population segment of the first partner to a second population segment of the first partner.

8. The method of claim 1 further comprising displaying, by the display, the report data in an activity mapping matrix including a plurality of cells representing overlaps between the respective population segments of the first partner and the second partner.

9. The method of claim 8, wherein a cell of the plurality of cells represents overlaps between a first population segment of the first partner and a second population segment of the second partner, and wherein the cell includes a count of overlaps between the first population segment and the second population segment.

10. The method of claim 8, wherein a cell of the plurality of cells represents overlaps between a first population segment of the first partner and a second population segment of the second partner, and wherein the cell includes a revenue of overlaps between the first population segment and the second population segment.

11. A computing system, comprising:
a memory to store population data representing respective population segments of a first partner and a second partner, wherein the respective population segments include a record overlapping between the first partner and the second partner; and
a processing device to:
determine a first match time at which the record has a first record status for one of the partners,
determine, in response to a change in the first record status to a second record status for one of the partners, a second match time of the record, and
generate, to present on a display, report data including the first match time and the second match time, wherein the report data representing a history of the record statuses.

12. The computing system of claim 11, wherein the processing device is further to determine an overlap of the record between the first partner and the second partner.

13. The computing system of claim 11 further comprising a display to present the report data in an activity timeline indicating movement of the record into the respective population segments of the first partner and the second partner.

14. The computing system of claim 11 further comprising a display to present the report data in an activity timeline indicating movement of the record from a first population segment of the first partner to a second population segment of the first partner.

15. The computing system of claim 11 further comprising a display to present the report data in an activity mapping matrix including a plurality of cells representing overlaps between the respective population segments of the first partner and the second partner.

16. A non-transitory computer readable medium storing instructions which, when executed by a processing device of a computing system, cause the computing system to:
receive, by the processing device, population data representing respective population segments of a first partner and a second partner, wherein the respective population segments include a record overlapping between the first partner and the second partner;
determine a first match time at which the record has a first record status for one of the partners;
determine, in response to a change in the first record status to a second record status for one of the partners, a second match time of the record; and
generate report data including the first match time and the second match time, wherein the report data includes a history of the statuses of the record.

17. The non-transitory computer readable medium of claim 16 storing instructions to cause the computing system to determine an overlap of the record between the first partner and the second partner.

18. The non-transitory computer readable medium of claim 16 storing instructions to cause the computing system to display the report data in an activity timeline indicating movement of the record into the respective population segments of the first partner and the second partner.

19. The non-transitory computer readable medium of claim 16 storing instructions to cause the computing system to display the report data in an activity timeline indicating movement of the record from a first population segment of the first partner to a second population segment of the first partner.

20. The non-transitory computer readable medium of claim 16 storing instructions to cause the computing system to display the report data in an activity mapping matrix including a plurality of cells representing overlaps between the respective population segments of the first partner and the second partner.
